(19) United States
(12) Patent Application Publication
(10) Pub. No.: US 2025/0124183 A1
(43) Pub. Date: Apr. 17, 2025

(54) APPARATUS AND METHODS FOR PREDICTING DIE SLIDING DURING A HOT FORMING PROCESS AND ASSOCIATED HOT FORM DIE

(71) Applicant: The Boeing Company, Arlington, VA (US)

(72) Inventors: Brian Griffin, St. Louis, MO (US); William F. Judd, St. Peters, MO (US); Ryan L. Hanks, Shipman, IL (US); Richard L. Fahey, JR., St. Louis, MO (US); Philip Steinacher, Carrolton, IL (US); Mario Slaughter, St. Charles, MO (US); Cody Nguyen, O'Fallon, MO (US); Andrew M. Dummerth, St. Louis, MO (US)

(21) Appl. No.: 18/485,876

(22) Filed: Oct. 12, 2023

(51) Int. Cl. G06F 30/20; G06F 119/18

(52) U.S. Cl. CPC G06F 30/20; G06F 2119/18

(57) ABSTRACT

An apparatus and method for predicting hot form die sliding are disclosed. The apparatus generates a 3D model of a hot form die, including a model upper die and a model lower die, which is fixed, relative to the model upper die. A hot forming process model is generated, and a baseline simulation is performed to determine a sliding direction of the model upper die within a sliding plane as it is pressed towards the model lower die along a z-axis. A spring coefficient is calculated at a spring reference point on the model upper die, that allows the model upper die to slide a specified distance in the sliding direction. If it is determined that some sliding is to be prevented, the apparatus generates model guides within the 3d model.

### FIELD

This disclosure relates generally hot forming apparatuses and processes, and more particularly to predicting die sliding during a hot forming process and minimizing die sliding during the hot forming process based on the predicted die sliding.

### BACKGROUND

Heavy dies used in hot forming processes for forming parts, such as titanium parts, exhibit a tendency to slide during operation. The occurrence of die sliding introduces significant risks to the hot forming process, including potential damage to the dies, production of out-of-tolerance parts, and disruptions in operational schedules.

Current three-dimensional (3D) modeling techniques, employed for die simulation and fabrication, model a die configuration where an upper die is movable along a z-axis, toward a lower die, but is fixed along the x-axis and the y-axis. Accordingly, conventional 3D modeling techniques do not account for die sliding. Instead, die sliding is accounted for only via trial-and-error techniques on a physical model, which is a time-consuming and resource wasting process.

### SUMMARY

The subject matter of the present application has been developed in response to the present state of the art, and in particular, in response to the problems of and needs created by, or not yet fully solved by, die sliding during hot forming processes. Although predicting and mitigating die sliding promotes time and cost savings, predicting force vectors associated with die sliding is complex and challenging. Conventional static modeling approaches that do not account for die sliding make such approaches unsuitable for anticipating and mitigating die sliding without engaging in physical-model trial-and-error techniques. Generally, the subject matter of the present application has been developed to provide an apparatus, and associated systems and methods, for predicting and minimizing die sliding that overcomes at least some of the above-discussed shortcomings of prior art techniques.

Disclosed herein is an apparatus for predicting hot form die sliding. The apparatus includes a processor. The apparatus also includes a memory that stores code executable by the processer to generate a 3D model of a hot form die. The 3D model includes a model upper die and a model lower die, and the model lower die is fixed relative to the model upper die. The apparatus also includes a memory that stores code executable by the processer to generate a hot forming process model for forming a part using the 3D model. The apparatus further includes a memory that stores code executable by the processer to perform a baseline simulation of the hot forming process model to determine a sliding direction of the model upper die within a sliding plane. The baseline simulation includes pressing the model upper die towards the model lower die in a pressing direction along a z-axis extending through a centroid of the model upper die while allowing the model upper die to freely slide within the sliding plane, which is perpendicular to the z-axis. Based on the baseline simulation, the apparatus also includes a memory that stores code executable by the processer to calculate a spring coefficient applied at a spring reference point on the model upper die, offset aft of the centroid along the sliding plane, that allows the model upper die to slide a specified distance in the sliding direction within the sliding plane. The apparatus also includes a memory that stores code executable by the processer to determine if at least a portion of sliding in the specified distance in the sliding direction is to be prevented. If determined that at least the portion of sliding in the specified distance in the sliding direction is to be prevented, the apparatus also includes a memory that stores code executable by the processer to generate at least one model guide in the 3D model. The at least one model guide includes model guide characteristics that prevent the model upper die from sliding at least the portion of sliding in the specified distance in the sliding direction. The preceding subject matter of this paragraph characterizes example 1 of the present disclosure.

The memory further stores code executable by the processor to generate multiple 3D models of the hot form die and perform multiple baseline simulations of the hot forming process model each corresponding with one of the multiple 3D models. Each one of the multiple 3D models is different from any other one of the multiple 3D models and is configured to make the part during the baseline simulation of the hot forming process model. Each one of the multiple 3D models is simulated to identify the one of the multiple 3D models that induces the least amount of sliding within the sliding plane. The preceding subject matter of this paragraph characterizes example 2 of the present disclosure, wherein example 2 also includes the subject matter according to example 1, above.

The specified distance is determined using historical data including sliding data obtained during a physical hot forming process using a hot form die comprising an upper die with a similar geometry and a similar weight to the model upper die and a lower die with a similar geometry and a similar weight to the model lower die. The spring coefficient is calculated using the specified distance. The preceding subject matter of this paragraph characterizes example 3 of the present disclosure, wherein example 3 also includes the subject matter according to any of examples 1-2, above.

The historical data includes sliding data obtained from at least two physical hot forming processes. The preceding subject matter of this paragraph characterizes example 4 of the present disclosure, wherein example 4 also includes the subject matter according to example 3, above.

The spring coefficient is calculated by multiplying a known spring coefficient of a second 3D model by a ratio of a first mass of the model upper die and a second mass of an upper die of the second 3D model. The specified distance is determined using the spring coefficient. The preceding subject matter of this paragraph characterizes example 5 of the present disclosure, wherein example 5 also includes the subject matter according to any of examples 1-4, above.

Model guide characteristics of the at least one model guide include at least one of a shape, a size, a material, or a placement of the at least one model guide relative to the model upper die and the model lower die. The preceding subject matter of this paragraph characterizes example 6 of the present disclosure, wherein example 6 also includes the subject matter according to any of examples 1-5, above.

The memory further store code executable by the processor to perform subsequent simulations using the spring coefficient to determine the model guide characteristics of the at least one model guide that prevent the model upper die from sliding at least the portion of sliding in the specified distance in the sliding direction. The preceding subject matter of this paragraph characterizes example 7 of the present disclosure, wherein example 7 also includes the subject matter according to any of examples 1-6, above.

The memory further stores code executable by the processor to generate manufacturing specifications for fabricating a physical hot form die that replicates the hot form die of the 3D model. The preceding subject matter of this paragraph characterizes example 8 of the present disclosure, wherein example 8 also includes the subject matter according to any of examples 1-7, above.

Also disclosed here is a hot form die. The hot form die includes an upper die and a lower die configured to be positionable beneath and fixed relative to the upper die during a hot forming process. The hot form die also includes at least one guide coupled to one of the upper die or the lower die, and configured to guide the upper die, relative to the lower die, during the hot forming process. During the hot forming process for forming a part, the upper die is configured to be pressed towards the lower die, in a pressing direction along a z-axis extending through a centroid of the upper die. Additionally, during the hot forming process, the upper die is prevented from sliding at least a portion of a specified distance in a sliding direction within a sliding plane, which is perpendicular to the z-axis, by the at least one guide. The at least one guide includes guide characteristics based on model guide characteristic of at least one model guide determined by an apparatus or predicting hot form die sliding. The apparatus generates a 3D model of the hot form die including a model upper model and a model lower die, and the model lower die is fixed, relative to the model upper die. The apparatus also generates a hot forming process model for forming a part using the 3D model. The apparatus further performs a baseline simulation of the hot forming process model to determine a sliding direction of the model upper die within a sliding plane. The baseline simulation includes pressing the model upper die towards the model lower die in a pressing direction along the z-axis extending through a centroid of the model upper die while allowing the model upper die to freely slide within the sliding plane, which is perpendicular to the z-axis. Based on the baseline simulation, the apparatus also calculates a spring coefficient applied at a spring reference point on the model upper die, offset aft of the centroid along the sliding plane, that allows the model upper die to slide the specified distance in the sliding direction within the sliding plane. The apparatus further generates the at least one model guide in the 3D model. The at least one model guide includes model guide characteristics that prevent the model upper die from sliding at least the portion of sliding in the specified distance in the sliding direction. The preceding subject matter of this paragraph characterizes example 9 of the present disclosure.

The upper die is fabricated to replicate the model upper die. The lower die is fabricated to replicate the model lower die. The preceding subject matter of this paragraph characterizes example 10 of the present disclosure, wherein example 10 also includes the subject matter according to example 9, above.

The apparatus for predicting hot form die sliding generate multiple 3D models of the hot form die and performs multiple baseline simulations of the hot forming process model each corresponding with one of the multiple 3D models. Each one of the multiple 3D models is different from any other one of the multiple 3D models and is configured to make the part during the baseline simulation of the hot forming process model. Each one of the multiple 3D models is simulated to identify the one of the multiple 3D models that induces the least amount of sliding within the sliding plane. The upper die and the lower die are formed to replicate the model upper die and the model lower die of the one of the multiple 3D models that induces the least amount of sliding within the sliding plane. The preceding subject matter of this paragraph characterizes example 11 of the present disclosure, wherein example 11 also includes the subject matter according to any of examples 9-10, above.

The at least one guide includes at least one guide block coupled to the upper die. The lower die includes a guide feature corresponding to the at least one guide block. The at least one guide block is configured to engage with the corresponding guide feature during the hot forming process. The preceding subject matter of this paragraph characterizes example 12 of the present disclosure, wherein example 12 also includes the subject matter according to any of examples 9-11, above.

The at least one guide includes at least one guide block coupled to the lower die. The upper die includes a guide feature corresponding to the at least one guide block. The at least one guide block is configured to engage with the corresponding guide feature during the hot forming process. The preceding subject matter of this paragraph characterizes example 13 of the present disclosure, wherein example 13 also includes the subject matter according to any of examples 9-11, above.

Guide characteristics of the at least one guide includes at least one of a shape, a size, a material, or a placement of the at least one guide relative to the upper die and the lower die. The preceding subject matter of this paragraph characterizes example 14 of the present disclosure, wherein example 14 also includes the subject matter according to any of examples 9-12, above.

The upper die and the lower die are configured to be heated to at least 1150 degrees F. during the hot forming process. The preceding subject matter of this paragraph characterizes example 15 of the present disclosure, wherein example 15 also includes the subject matter according to any of examples 9-14, above.

Further disclosed herein is a method of predicting die sliding during a hot forming process. The method includes the step of generating a 3D model of a hot form die. The 3D model includes a model upper die and a model lower die, and the model lower die is fixed relative to the model upper die. The method also includes the step of generating a hot forming process model for forming a part using the 3D model. The method further includes the step of performing a baseline simulation of the hot forming process model to determine a sliding direction of the model upper die within a sliding plane. The baseline simulation comprises pressing the model upper die towards the model lower die in a pressing direction along a z-axis extending through a centroid of the model upper die while allowing the model upper die to freely slide within the sliding plane, which is perpendicular to the z-axis. Based on the baseline simulation, the method also includes the step of calculating a spring coefficient applied at a spring reference point on the model upper die, offset aft of the centroid along the sliding plane, that allows the model upper die to slide a specified distance in the sliding direction within the sliding plane. The method further includes the step of determining if at least a portion of sliding in the specified distance in the sliding direction is to be prevented. If determined that at least the portion of sliding in the specified distance in the sliding direction is to be prevented, the method also includes the step of generating at least one model guide in the 3D model. The at least one model guide including model guide characteristics that prevent the model upper die from sliding at least the portion of sliding in the specified distance in the sliding direction. The preceding subject matter of this paragraph characterizes example 9 of the present disclosure.

The step of generating the 3D model of a hot form die includes generating multiple 3D models of the hot form die. The step of performing the baseline simulation of the hot forming process model includes performing multiple baseline simulations of the hot forming process model each corresponding with one of the multiple 3D models. Each one of the multiple 3D models is different from any other one of the multiple 3D models and is configured to make the part during the baseline simulation of the hot forming process model. Each one of the multiple 3D models is simulated to identify the one of the multiple 3D models that induces the least amount of sliding within the sliding plane. The preceding subject matter of this paragraph characterizes example 17 of the present disclosure, wherein example 17 also includes the subject matter according to example 16, above.

The specified distance is determined using historical data including sliding data obtained during a physical hot forming process using a hot form die including an upper die with a similar geometry and a similar weight to the model upper die and a lower die with a similar geometry and a similar weight to the model lower die. The spring coefficient is calculated using the specified distance. The preceding subject matter of this paragraph characterizes example 18 of the present disclosure, wherein example 18 also includes the subject matter according to any of examples 16-17, above.

The spring coefficient is calculated by multiplying a known spring coefficient of a second 3D model by a ratio of a first mass of the model upper die and a second mass of an upper die of the second 3D model. The specified distance is determined using the spring coefficient. The preceding subject matter of this paragraph characterizes example 19 of the present disclosure, wherein example 19 also includes the subject matter according to any of examples 16-18, above.

The method includes the step of generating manufacturing specifications for fabricating a physical hot form die that replicates the hot form die of the 3D model. The preceding subject matter of this paragraph characterizes example 20 of the present disclosure, wherein example 20 also includes the subject matter according to any of examples 16-19, above.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic block diagram illustrating one embodiment of an apparatus for predicting die sliding during a hot forming process, according to one or more examples of the present disclosure;

FIG. 2A is a schematic perspective view of a 3D model of a hot form die, with a plate between a model upper die and a model lower die, according to one or more examples of the present disclosure;

FIG. 2B is a schematic perspective view of the 3D model of FIG. 1A, with a part between the model upper die and the model lower die, according to one or more examples of the present disclosure;

FIG. 3 is a schematic perspective view of the 3D model of FIG. 2A, with a plurality of guides and corresponding guide features, according to one or more examples of the present disclosure;

FIG. 4A is a schematic perspective view of a first 3D model design of a hot form die, with a plate between a model upper die and a model lower die, according to one or more examples of the present disclosure;

FIG. 4B is a schematic perspective view of a second 3D model design of a hot form die, with a plate between a model upper die and a model lower die, according to one or more examples of the present disclosure;

FIG. 4C is a schematic perspective view of a third 3D model design of a hot form die, with a plate between a model upper die and a model lower die, according to one or more examples of the present disclosure;

FIG. 4D is a schematic perspective view of a fourth 3D model design of a hot form die, with a plate between a model upper die and a model lower die, according to one or more examples of the present disclosure;

FIG. 4E is a chart comparing hot form die sliding between the 3D models of FIGS. 4A-4D, according to one or more examples of the present disclosure;

FIG. 5A is a schematic perspective view of a hot form die, according to one or more examples of the present disclosure;

FIG. 5B is a schematic perspective view of a part formed by the hot form die of FIG. 5A, according to one or more examples of the present disclosure;

FIG. 6 is a schematic perspective view of a hot form die, with a plate between an upper die and a lower die, according to one or more examples of the present disclosure;

FIG. 7 is a schematic perspective view of a hot form die, within a press, according to one or more examples of the present disclosure;

FIG. 8 is a schematic block diagram of a method of fabricating a hot form die and performing a hot forming process with the hot form die, according to one or more examples of the present disclosure; and

FIG. 9 is a schematic block diagram of a method of predicting die sliding during a hot forming process, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the subject matter of the present disclosure, however, absent an express correlation to indicate otherwise, an implementation may be associated with one or more examples.

These features and advantages of the embodiments will become more fully apparent from the following description and appended claims or may be learned by the practice of the examples of the present disclosure as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Disclosed herein are examples of an apparatus and method for predicting die sliding during a hot forming process and an associated hot form die formed according to the results provided by the apparatus and method. The following provides some features of at least some examples of the apparatus and method for predicting die sliding. In the process of hot forming, a fundamental challenge arises from the tendency of heavy dies (e.g., hot form dies), particularly those used in shaping titanium and other materials, to undergo undesired lateral movements, commonly referred to as die sliding. Since die sliding during a hot forming process is difficult to predict, often a trial-and-error approach is undertaken to modify the hot form die to prevent die sliding. Typically, this entails using a first part produced during a test hot forming process to gauge an extent and direction of die sliding. Unfortunately, this initial part usually falls outside acceptable tolerances due to die sliding, rendering it unsuitable and resulting in wastage. Based on the testing of the hot forming process, modifications are often attempted on the hot form die to minimize die sliding and achieve production of parts that meet precise tolerances. Modifications may include adding guides to the hot form die, modifying a shape or size of the hot form die, or changing the hot forming testing parameters. However, this conventional approach is neither desirable nor cost-effective, as it necessitates an often multiple-day duration and repeated process for the hot form die to attain the required forming temperature, followed by an additional waiting period for it to cool to a safe, manageable room temperature. Ideally, uninterrupted use of the hot form die for the formation of multiple parts, which does not require a physical trial-and-error and modification approach with repetitive heating and cooling processes, is desired.

Therefore, the apparatus disclosed herein enables a traditional trial-and-error approach to be avoided by utilizing a 3D model and a hot forming process model to perform simulations, which predict sliding, prior to physical hot forming processes. These simulations can be used to determine force vectors associated with the hot form die, allowing for the prediction of both a direction and extent of die sliding during the simulated hot forming process. This prediction is facilitated through the development of a spring coefficient. Furthermore, subsequent simulations, utilizing the spring coefficient, aid in determining model guides and their associated guide characteristics that can mitigate at least a portion of die sliding. Moreover, simulations can be employed to determine an optimal design for the 3D model that minimizes die sliding. By minimizing die sliding in physical hot forming processes, stress on the hot form die and other forming equipment is reduced prolonging their life expectancy and resulting in production of more parts that meet tolerance requirements and also exhibit greater geometric consistency.

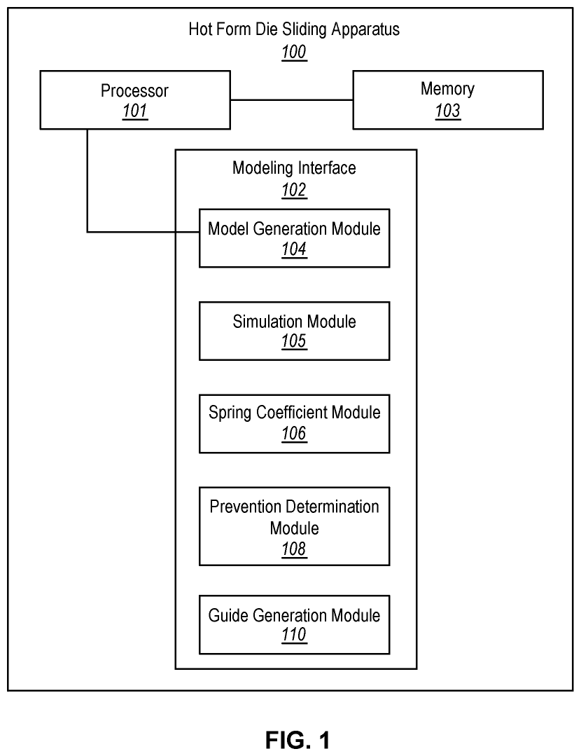

Referring to FIG. 1, according to one example, an apparatus 100 for predicting die sliding during a hot forming process is shown. As shown, the apparatus 100 includes a processor 101, a modeling interface 102, and memory 103. In various embodiments, non-transitory computer readable instructions (i.e., code) stored in the memory 103 (i.e., storage media) cause the processor 101 to predict die sliding during a hot forming process. The processor 101 (e.g., central processing unit) may be incorporated into various computing device, such as a desktop computer, a laptop computer, a tablet computer, a smart phone, a smart watch, a smart TV, etc. In some examples, a web-based portal may facilitate access to the processor 101, allowing the apparatus 100 to be utilized remotely, regardless of a physical location in relation to the processor 101. The modeling interface 102 may include embodiments of a model generation module 104, a simulation module 105, a spring coefficient module 106, a prevention determination module 108, and a guide generation module 110, which are described in more detail below.

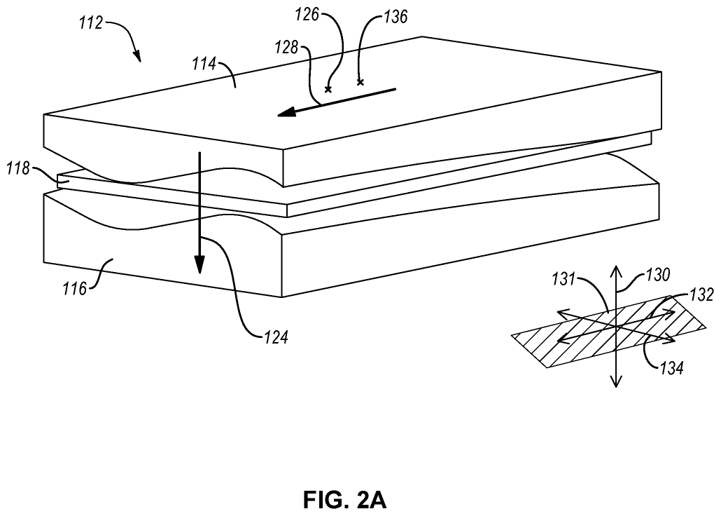

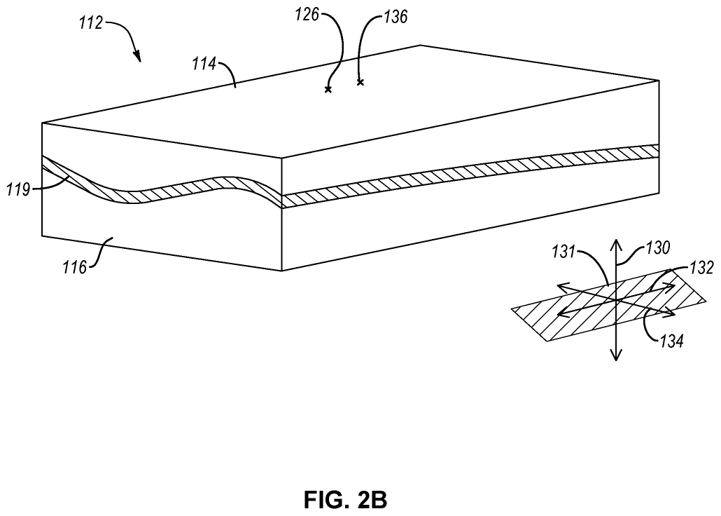

In one example, the model generation module 104 is configured to generate a 3D model of a hot form die, shown and described below in reference to FIG. 2. The 3D model includes a model upper die and a model lower die. The 3D model is generated to replicate an existing physical hot form die, or, alternatively, the specifications of the 3D model are configured to be used as a reference for fabricating a new physical hot form die. The model lower die, of the 3D model, is fixed relative to the model upper die, such that the 3D model can be used to predict die sliding in the model upper die, relative to the fixed model lower die. The model generation module 104 is also configured to generate a hot forming process model for forming a part using the 3D model. That is, the model generation module 104 is used to generate the 3D model and the hot forming process using the 3D model. The hot forming process is used to form a plate (e.g., piece of raw material, pre-form, billet of material, etc.) into a part (see, e.g., FIGS. 2A-2B).

The simulation module 105 is configured to perform simulations of the hot forming process model. As used herein, a hot forming process is a process used to shape or transform metal or other materials while at an elevated temperature, which making the transformed material more malleable and easier to deform. Hot forming allows for parts with complex shapes and precise tolerances to be achieved and is often a cost-effective method to produce complex parts versus machining the parts from blocks of material. Hot forming techniques are often preferred when forming titanium parts from titanium plates using laminated dies. The laminated dies are configured to withstand high temperatures used during the hot forming process. For example, a hot forming process for forming a titanium plate into a part may require the titanium plate to be heated to temperatures between 1150 degrees F. to 1450 degrees F. This requires heating of the hot form die (and guides) to temperatures of at least 100 degrees F. higher in order to achieve the proper temperature in the titanium plate.

In some examples, the simulation module 105 performs a baseline simulation that is employed to determine a sliding direction of the model upper die within a sliding plane. In many cases, manually predicting which direction the model upper die will slide, relative to the model lower die, is not possible. Accordingly, the baseline simulation is used to determine the sliding direction. During simulations of the hot forming process model, the model upper die is pressed towards the model lower die in a pressing direction along a z-axis that extends through a centroid of the model upper die. The model upper die is allowed to freely slide within the sliding plane, which is perpendicular to the z-axis. That is, the sliding plane is parallel or co-planar to a plane defined by an x-axis and a y-axis, and serves as a two-dimensional reference surface for movement of the model upper die. In some examples, the model upper die is fixed relative to one of the x-axis or the y-axis, such that the model upper die can only slide in one direction, such as a forward-to-back direction or a side-to-side direction. For example, movement of the model upper die may be restricted to either the x-axis or the y-axis when a press, to be used with a physical hot form die which is based on the 3D model, does not permit movement along a specific axis. The simulation module 105 may also be used to perform subsequent simulations, after the baseline simulation, such as simulations to determine a spring coefficient or simulations to determine optimal guide characteristics. Any number of simulations can be performed using the 3D model to determine and optimize the specifications of the 3D model. Using the simulation module 105 to quickly perform multiple simulations with different forming planes and force vectors allows for a resulting fabricated hot form die, based on the simulation results, to be safer and more consistent in performance. Fabrication risk with a hot form die can be avoided due to the simulation module 105 being used to optimize forming variables early in the design process form the hot form die.

The spring coefficient module 106 is configured to calculate a spring coefficient for the 3D model. The spring coefficient corresponds to the level of stiffness that permits the model upper die to slide a specified distance (i.e., predetermined distance) in the sliding direction within the sliding plane. As used herein, the specified distance is the distance that a physical hot form die will naturally slide during a hot forming process, when sliding is not prevented or mitigated by mitigation measures. The specified distance may be obtained through physical testing of a hot form die, or calculated without the use of a physical hot form die. In order to determine the specified distance, or model the specified distance in the 3D model a spring coefficient is calculated and applied to the 3D model. The spring coefficient is applied at a spring reference point on the model upper die that is located aft of the centroid of the model upper die along the sliding direction.

In some examples, historical data, including sliding data obtained during a physical hot forming process, is used for the spring coefficient calculation. These physical hot forming processes involve upper dies and lower dies with similar geometry and similar weight to those of the model counterparts. The historical data used may be from a physical hot forming process employing the same upper and lower dies used for modeling the 3D model. Alternatively, the historical data may come from a physical hot forming process involving upper and lower dies closely matching the 3D model, with minor variations in die weights or geometry. In addition to sliding data, historical data may also include information such as temperature profiles, pressure profiles, material properties, cycle time, and press specifications. Sliding data is collected during a physical hot forming process by measuring a displacement of the upper die from its nominal position before and after the hot forming process. That is, the sliding data represents the specified distance that the model upper die is allowed to slide in the sliding direction within the sliding plane. In some examples, the historical data includes sliding data obtained from at least two physical hot forming processes, which may be averaged or otherwise combined. In other examples, the number of physical hot forming processes used for historical data can vary. Simulations, conducted using the simulation module 105, involve testing different stiffness values (e.g., measured in lbs./inch) until identifying the stiffness that results in the model upper die sliding the same distance in the sliding direction as observed in the sliding data (i.e., specified distance). This identified stiffness value becomes the calculated spring coefficient. In other words, the spring coefficient is calculated using the specified distance.

In other examples, the spring coefficient is calculated using a calibration model. The calibration model (i.e., second 3D model) features constants for a mass of an upper die (m₁) and a spring coefficient (k₁) of the calibration model, which are known values. Using these constants, the spring coefficient (k₂) can be calculated for the 3D model. As a mass of the model upper die of the 3D model (m₂) is known, the following formula can be used to calculate k₂: k₂=k₁*(m₂/m₁). That is, the formula links a calibrated spring coefficient from the calibration model to other 3D model configurations. In other words, the spring coefficient is calculated by multiplying a known spring coefficient of a second 3D model (i.e., calibration model) by a ratio of a first mass of the model upper die and a second mass of an upper die of the second 3D model. Subsequently, the specified distance is determined using the calculated spring coefficient. Accordingly, the simulation module 105 is used to determine an amount of die sliding in the model upper die, using the calculated spring coefficient. That is, by using a calibration model, it is not necessary to rely on sliding data collected from a physical hot forming process to calculate the spring coefficient. Consequently, the model generation module 104 may be used to generate new 3D models that are not based on existing hot form dies with historical data and still obtain a spring coefficient for the new 3D model.

The prevention determination module 108 is configured to determine whether it is necessary to prevent any part of the sliding in the specified distance. In some cases, the 3D model may allow for some degree of sliding if it does not result in damage to the upper or lower dies, still produces parts within acceptable tolerances, and/or enables the production of multiple parts in a single hot forming process. That is, not all die sliding needs to be eliminated. Consequently, the prevention determination module 108 determines whether the specified distance in the sliding direction is acceptable or if it exceeds an acceptable limit, requiring the prevention of at least a portion of sliding in the specified distance. For example, if it is determined that any sliding exceeding a distance, such as 0.10 inches, is to be avoided then the prevention determination module 108 assesses whether the specified distance, measured either from historical sliding data or calculated using the spring coefficient module 106, exceeds 0.10 inches, indicating the need for prevention.

If it is determined that at least the portion of sliding in the specified distance is to be prevented, the guide generation module 110 is configured to generate at least one model guide in the 3D model. The model guide or multiple model guides includes model guide characteristics that prevent the model upper die from sliding at least the portion of sliding in the specified distance, that is, the portion of sliding that needs to be prevented. The model guide characteristics may include various factors including but not limited to a shape of the guide, a size of the guide, a material composition of the guide, or a placement of the guide relative to the model upper die and the model lower die. In some examples, a model guide made of a first material may be sufficient for the 3D model, however, in other examples, a model guide made of a second material, having a greater strength compared to the first material may be required. For example, stainless steel model guides may be suitable for some 3D models, whereas other 3D models may demand Inconel model guides, having a greater strength than stainless steel model guides. The model guides 120 may be coupled to either the model upper die or the model lower die.

Subsequent simulation, using the simulation module 105, may be performed using the calculated spring coefficient to determine the model guide characteristics that prevent the model upper die from sliding the specified distance, and thus can be used to mitigate die sliding. Multiple subsequent simulations may be performed to optimize the guide characteristics based on the mitigation of the model guides.

Additionally, the apparatus 100 may include a fabrication module. The fabrication module is configured to generate manufacturing specifications for fabricating a physical hot form die that replicates the hot form die of the 3D model, based on the results of the simulations. As such, the manufacturing specifications include specifications for forming guides, if necessary, to prevent some die sliding during a hot forming process using the physical hot form die.

Referring to FIGS. 2A-2B, one example of a 3D model 112 is shown. The 3D model 112 is modeled using the apparatus 100. The 3D model 112 includes a model upper die 114 and a model lower die 116. The 3D model 112 represents a hot form die designed to be used in a press, where an upper die moves along a z-axis 130, vertically, toward a lower die to form a part. This requires that the model upper die 114 is positioned vertically above the model lower die 116. Consequently, when a force is applied in a pressing direction 124 along the z-axis 130 which passes through a centroid 126 of the model upper die 114, the features of the model upper die 114 and the model lower die 116 are configured to maintain vertical alignment in order to produce parts that are within tolerance. Accordingly, die sliding in a sliding direction 128, by the model upper die 114, relative to the model lower die 116, may cause the 3D model 112 to produce out-of-tolerance parts. The sliding direction 128 can be determined using historical data related to the hot form die represented by the 3D model 112, or it can be determined by performing a simulation using the 3D model 112. In some examples, the model upper die 114 is allowed to freely slide within a sliding plane 131, which is parallel or co-planar to a plane defined by an x-axis 132 and a y-axis 134, perpendicular to the z-axis 130. In such cases, the sliding direction 128 can be in any direction within the sliding plane 131. Alternatively, in other examples, the 3D model 112 is fixed relative to one of the x-axis 132 or the y-axis 134. For example, the 3D model 112 is fixed relative to the y-axis 134, as a press the 3D model 112 is configured to be used within restricts movement along the y-axis 134, therefore, the sliding direction 128 is along the x-axis 132.

The spring coefficient, described above, is employed to predict die sliding in the sliding direction 128 by the model upper die 114. The spring coefficient is calculated, as described above, and applied at a spring reference point 136, offset aft of the centroid 126, in a direction opposite of the sliding direction 128. Moreover, the spring coefficient is used to determine a specified distance (i.e., sliding distance) that the model upper die 114 will slide in the sliding direction 128 within the sliding plane 131.

A plate 118 is configured to be placed between the model upper die 114 and the model lower die 116, as shown in FIG. 2A. The plate 118 may be formed of any material that would be formed into a part using a hot forming process. In some examples, the plate 118 is a titanium plate. When performing a simulation of the hot forming process model using the 3D model 112, the plate 118 is formed into a part 119, as shown in FIG. 2B.

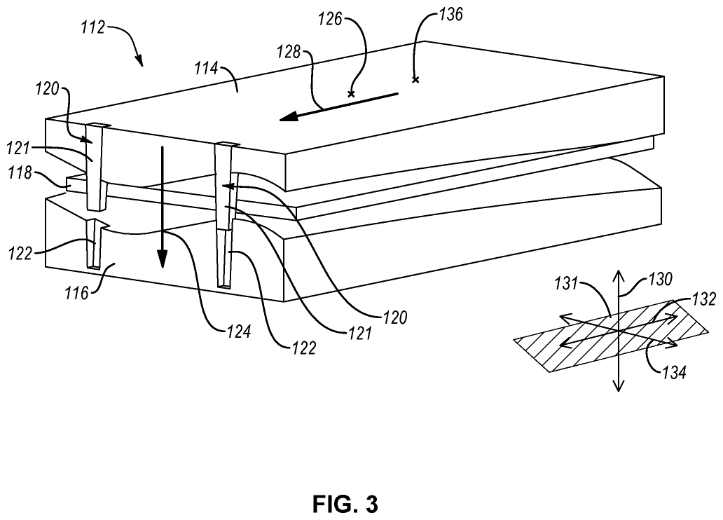

As shown in FIG. 3, one or more model guides 120 are introduced to the 3D model 112 to prevent the model upper die 114 from sliding at least a portion of the specified distance. In other words, these model guides 120 serve as a mitigation measure to mitigate at least a portion of die sliding in the model upper die 114, relative to the model lower die 116. Accordingly, the model guides 120 serve the purpose of aligning, stabilizing, and otherwise guiding the movement of the model upper die 114, relative to the model lower die 116 to prevent or mitigate undesirable lateral movements (i.e., die sliding) during the hot forming process. Although FIG. 3 shows the inclusion of two model guides 120, more or fewer model guides 120 may be added to the 3D model 112 depending on the parameters of the 3D model 112. Additionally, model guides 120 may be applied to various surfaces of both the model upper die 114 or the model lower die 116 and are not limited to the arrangement shown in FIG. 3.

The model guides 120 have model guide characteristics that prevent the model upper die 114 from sliding at least a portion of the specified distance. Moreover, model guide characteristics are configured to safeguard the model guides 120 against potential damage during the hot forming process, including undesirable bending or shear forces. Model guide characteristics may include various factors including but not limited to, a shape of the model guide 120, a size of the model guide 120, a material composition of the model guide 120, or a placement of the model guide 120 relative to the model upper die 114 and the model lower die 116. For example, the shape of the model guide 120 may be in the form of a rod, a block, a panel, etc. Simulations may be performed to determine the optimal guide characteristics for the model guides 120.

In some examples, the model guide 120 is a model guide block 121. The model guide block 121 is a structural component coupled to the 3D model 112 and designed to engage with a corresponding model guide feature 122 during a hot forming process. For example, as shown in FIG. 3, two model guide blocks 121 are coupled to the model upper die 114 and configured to slide within the corresponding model guide features 122 on the model lower die 16, as the model upper die 114 is pressed in the pressing direction 124 towards the model lower die 116. Alternatively, the model guide blocks 121 may be coupled to the model lower die 116 and configured to slide within corresponding model guide features 122 on the model upper die 114. The model guide blocks 121 may be in the form of a rectangular or square block shape.

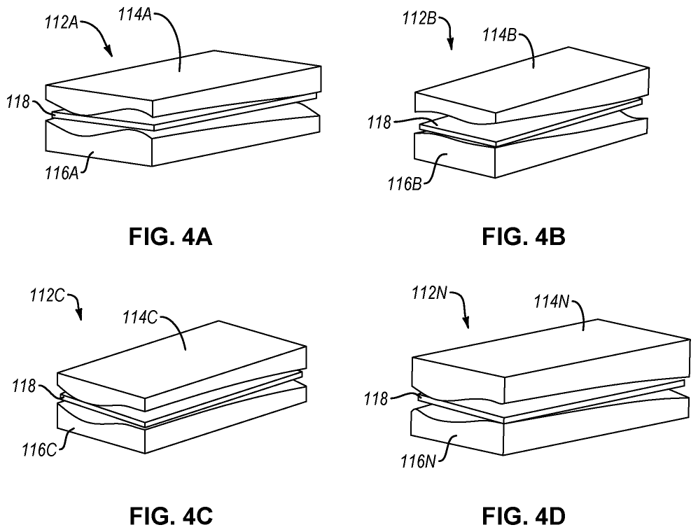

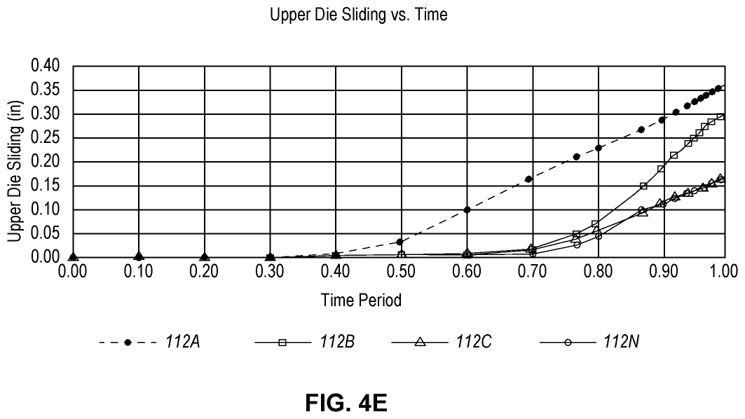

As shown in FIGS. 4A-4E, in some examples, the model generation module 104 and simulation module 105 of the apparatus 100 can be used to model multiple 3D models and identify which 3D model of the multiple 3D models induces the least amount of sliding within the sliding plane. Accordingly, the model generation module 104 is employed to generate multiple 3D models. Although shown with four 3D models 112A-112N, any number of 3D models, up to N number of models, can be modeled, as desired. For example, FIG. 4A shows a first 3D model 112A with a model upper die 114A and a model lower die 116A, FIG. 4B shows a second 3D model 112B with a model upper die 114B and a model lower die 116B, FIG. 4C shows a third 3D model 112C with the model upper die 114C and a model lower die 116C, and FIG. 4D shows a fourth 3D model 112N with a model upper die 114N and a model lower die 116N. Each one of the 3D models 112A-112N are different from any other ones of the multiple 3D models 112A-112N, such that there are variations between the model upper dies 114A-114N and/or the model lower dies 116A-116N. Moreover, each one of the 3D models 112A-112N is configured to produce a part from the plate 118 during a hot forming process. In other words, despite variations between each one of the 3D models 112A-112N, all of the 3D models 112A-112N are configured to produce a part having the same specifications and tolerances and a part produced by others of the 3D models. Accordingly, the model generation module 104 facilitates the modeling of multiple 3D models with variations such as model thickness, model material, model curvature, etc. Performing simulations of each one of the 3D models 112A-112N enables identification of the 3D model 112A-112N that, in addition to producing a part, will induce the least amount of sliding and require fewer mitigation measures to reduce die sliding. FIG. 4E illustrates this process, where data pertaining to die sliding for each of the 3D models 112A-112N is compared, such as represented visually on a graph, to determine which 3D model 112A-112N induces the least sliding.

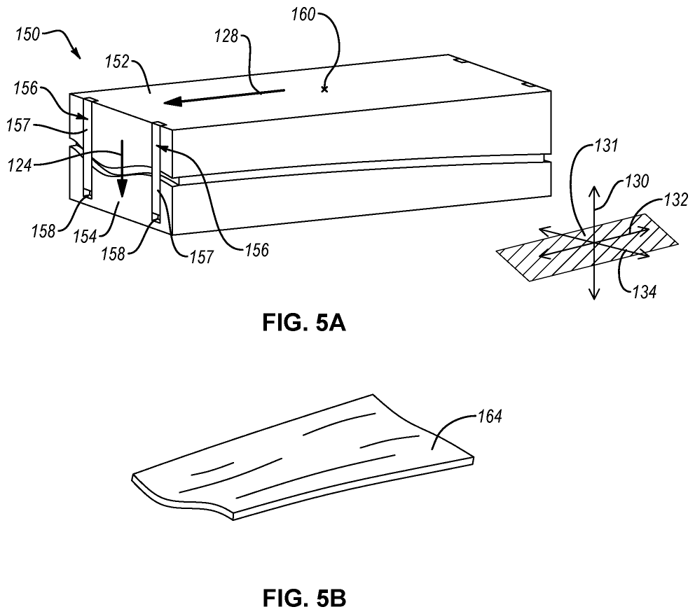

Referring to FIG. 5A-5B a hot form die 150 is shown. The hot form die is a physical hot form die. Unlike modeled hot form dies used in the apparatus 100, which are virtual representations used for simulations and modeling purposes, the hot form die is an actual, physical tool used in the manufacturing or shaping of materials, such as metal plates, in hot forming processes. The hot form die 150 includes an upper die 152 and a lower die 154. Similar to the 3D models above, the upper die 152 is configured to be positioned vertically above the lower die 154, during the hot forming process. Using a press, as shown in FIG. 7, a force is applied in a pressing direction 124 through a centroid 160 of the upper die 152, such that the upper die 152 is configured to maintain its vertical alignment with the lower die 154 in order to produce a part 164, shown in FIG. 5B, that is within tolerance. As die sliding in a sliding direction 128 by the upper die 152 may cause the hot form die 150 to produce out-of-tolerance parts or cause damage to the hot form die 150, at least one guide 156 is coupled to the hot form die 150 and configured to guide the upper die 152, relative to the lower die 154, during the hot forming process. The guides 156 may be coupled to the upper die 152 or the lower die 154, depending on the needs of the hot form die 150. The sliding direction 128 is shown as parallel to the x-axis 132, but could be any direction within the sliding plane 131.

The guides 156 have guide characteristics based on model guide characteristics of a model guide determined by the apparatus 100. That is, the apparatus 100 is used to model the hot form die 150 and test the 3D model, using simulations, to determine model guide characteristics. Accordingly, at least one of a shape, a size, a material, or a placement of the guides 156 relative to the upper die 152 and the lower die 154 may be determined using the apparatus 100. As shown, the upper die 152 includes at least two guides 156 as guide blocks 157 that are engaged with a corresponding guide feature 158 in the lower die 154. However, in other examples, the guides 156 may be coupled to the lower die 154 and configured to engage with corresponding guide features 158 on the upper die 152.

In some examples, the apparatus 100 is initially employed for the design and simulation of a 3D model, which is intended to produce a desired part. The 3D model includes model guides that are incorporated to mitigate die sliding within the 3D model. Subsequently, based on the 3D model and simulation results, a physical hot form die, such as the hot form die 150, can be manufactured. That is, an upper die, such as the upper die 152, is fabricated to replicate a model upper die, and a lower die, such as the lower die 154, is fabricated to replicate a model lower die. In other examples, a physical hot form die is already in use, and the apparatus 100 is employed to determine the optimal placement or necessary modifications to the guides on the hot form die to effectively mitigate die sliding.

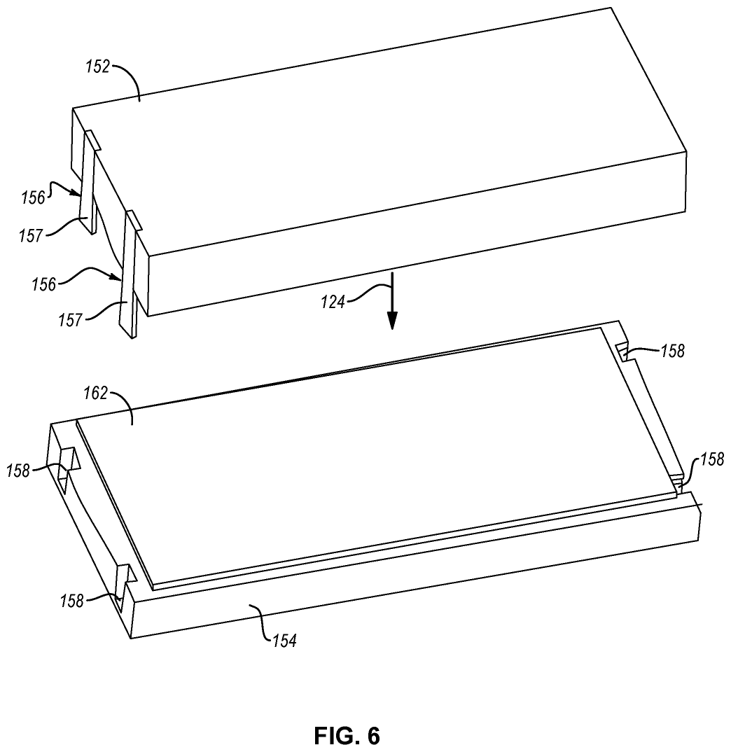

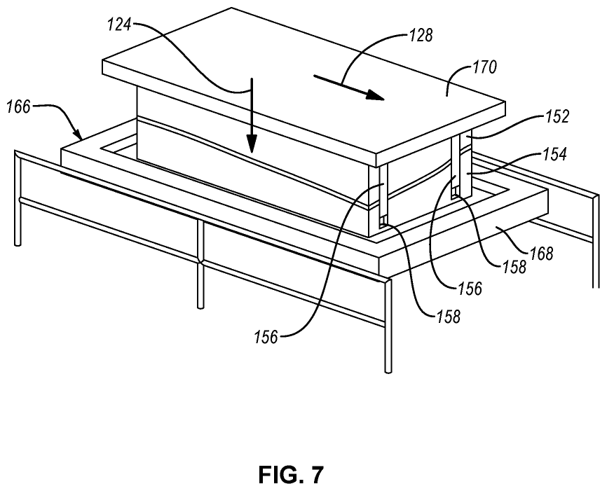

In FIGS. 6 and 7, a hot forming process using the hot form die 150 is shown. A plate 162 is placed on the lower die 154, which has been preheated to a required temperature, often significantly higher than the forming temperature of the plate 162 itself. The upper die 152, which replicates the configuration of the model upper die and model guides from earlier simulations using the apparatus 100, is then pressed in the pressing direction 124 along the z-axis 130. The hot forming process takes place within a press 166, where the lower die 154 is positioned on a lower press platen 168, and an upper press platen 170 is used to apply pressure on the upper die 152, forcing it toward the lower die 154. As the upper die 152 descends, the plate 162 is subjected to the elevated temperature and pressure, making it more malleable and amendable to deformation. The guides 156 mitigate die sliding in the upper die 152, relative to the lower die 154 as the upper die 152 descends toward the lower die 154. The precision of the hot forming process, optimized for die sliding using the apparatus 100, leads to reduced stress on the equipment, extended tool life, increased production efficiency, and the production of parts that consistently meet stringent tolerance requirements.

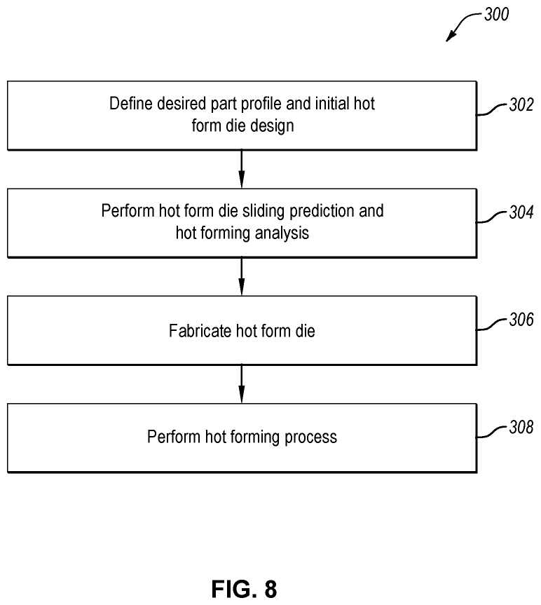

Referring to FIG. 8, according to some examples, a method 300 of fabricating a hot form die and performing a hot forming process using the hot form die is shown. The method 300 includes (block 302) defining a desired specification and profile of a part and an initial hot form die design that will be used to form the part. That is, the specific characteristics and dimensions the part are determined and the initial design of the hot form die to facilitate the part is considered. The method 300 also includes (block 304) performing a hot form die sliding prediction and hot forming process analysis. Accordingly, the apparatus 100 described in reference to FIG. 1, is used to generate a 3D model based on the initial hot form die design and simulations are performed to predict and mitigate die sliding in the 3D model. Modifications may be made to the 3D model and model guides added to mitigate die sliding in the 3D model. Based on results from the analysis of the 3D model using the apparatus 100, the method 300 further includes (block 306) fabricating a hot die form that replicates the 3D model and simulation outcomes. In other words, the hot die form, having the same design and specifications as the 3D model is fabricated. Additionally, the method 300 includes (block 308) performing a hot forming process using the hot form die to produce the part, which was defined in block 302. Using the method 300 to produce parts in a hot forming process leads to heightened precision in final parts, increased production efficiency, and prolonged tool life.

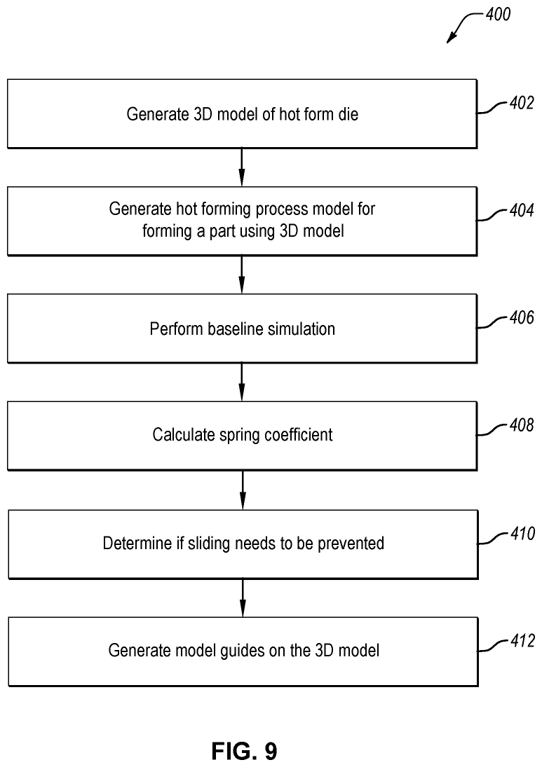

Referring to FIG. 9, according to some examples, a method 400 of predicting die sliding during a hot forming process is shown. The method 400 includes (block 402) generating a 3D model of a hot form die. The 3D model includes a model upper die and a model lower die, where the model lower die is fixed relative to the model upper die. In some examples, the 3D model is based on a physical hot form die. In other examples, the 3D model is configured to represent a future hot form die. Additionally, in some examples, multiple 3D models of the hot form die may be generated, where each one of the multiple 3D models is configured to produce the same part and each one of the multiple 3D models is different from the others. Simulations are later used to determine which 3D model produces the least amount of sliding. The method 400 also includes (block 404) generating a hot forming process model for forming a part using the 3D model. The method 400 further includes (block 406) performing a baseline simulation of the hot forming process model to determine a sliding direction of the model upper die within a sliding plane. The baseline simulation includes pressing the model upper die towards the model lower die in a pressing direction along a z-axis extending through a centroid of the model upper die while allowing the model upper die to freely slide within the sliding place, which is perpendicular to the z-axis. In other words, the baseline simulation is performed to determine the sliding direction as the sliding direction may be difficult to predict. Subsequent simulations, after the baseline simulation, are used to determine other attributes of the 3D model such as a spring coefficient, a specified distance of die sliding, and model guide characteristics.

Based on the baseline simulation, the method 400 also includes (block 408) calculating a spring coefficient applied at a spring reference point on the model upper die, offset aft of the centroid along the sliding plane. The spring coefficient allows the model upper die to slide a specified distance in the sliding direction within the sliding plane. In some examples, the spring coefficient is calculated by analyzing historical data obtained from physical hot forming processes, where the historical data including sliding data. Simulations using the sliding data can be performed to determine the spring coefficient that allows the model upper die to slide the same amount as the sliding data within the historical data. In other examples, the spring coefficient is calculated using a calibration model.

The method 400 further includes (block 410) determining if at least a portion of sliding in the specified distance in the sliding direction is to be prevented. In some cases, after performing a simulation of the 3D model, it may be determined that die sliding of the model upper die, relative to the model lower die is within acceptable tolerances, and therefore die sliding does not need to be prevented, using model guides, within the 3D model. However, in other cases, it may be determined that some die sliding needs to be prevented (i.e., mitigated) using model guides. If determined that at least the portion of sliding in the specified distance in the sliding direction is to be prevented, the method 400 additionally includes (block 412) generating at least one model guide in the 3D model. The at least one guide includes model guide characteristics that prevent the model upper die from sliding at least the portion of sliding in the specified distance in the sliding direction. In some examples, the method 400 further includes generating manufacturing specifications for fabricating a physical hot form die that replicates the hot form die of the 3D model.

Many of the functional units described in this specification have been labeled as modules, to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the examples herein are to be embraced within their scope.

What is claimed is:

1. An apparatus for predicting die sliding during a hot forming process, comprising:
a processor; and
a memory that stores code executable by the processer to:
generate a 3D model of a hot form die, the 3D model comprising a model upper die and a model lower die, wherein the model lower die is fixed relative to the model upper die;
generate a hot forming process model for forming a part using the 3D model;
perform a baseline simulation of the hot forming process model to determine a sliding direction of the model upper die within a sliding plane, wherein the baseline simulation comprises pressing the model upper die towards the model lower die in a pressing direction along a z-axis extending through a centroid of the model upper die while allowing the model upper die to freely slide within the sliding plane, which is perpendicular to the z-axis;
based on the baseline simulation, calculate a spring coefficient applied at a spring reference point on the model upper die, offset aft of the centroid along the sliding plane, that allows the model upper die to slide a specified distance in the sliding direction within the sliding plane;
determine if at least a portion of sliding in the specified distance in the sliding direction is to be prevented; and
if determined that at least the portion of sliding in the specified distance in the sliding direction is to be prevented, generate at least one model guide in the 3D model, wherein the at least one model guide comprises model guide characteristics that prevent the model upper die from sliding at least the portion of sliding in the specified distance in the sliding direction.

2. The apparatus of claim 1, wherein:
the memory further stores code executable by the processor to generate multiple 3D models of the hot form die and perform multiple baseline simulations of the hot forming process model each corresponding with one of the multiple 3D models;
each one of the multiple 3D models is different from any other one of the multiple 3D models and is configured to make the part during the baseline simulation of the hot forming process model; and
each one of the multiple 3D models is simulated to identify the one of the multiple 3D models that induces the least amount of sliding within the sliding plane.

3. The apparatus of claim 1, wherein:
the specified distance is determined using historical data comprising sliding data obtained during a physical hot forming process using a hot form die comprising an upper die with a similar geometry and a similar weight to the model upper die and a lower die with a similar geometry and a similar weight to the model lower die; and
the spring coefficient is calculated using the specified distance.

4. The apparatus of claim 3, wherein the historical data comprises sliding data obtained from at least two physical hot forming processes.

5. The apparatus of claim 1, wherein:
the spring coefficient is calculated by multiplying a known spring coefficient of a second 3D model by a ratio of a first mass of the model upper die and a second mass of an upper die of the second 3D model; and
the specified distance is determined using the spring coefficient.

6. The apparatus of claim 1, wherein model guide characteristics of the at least one model guide comprises at least one of a shape, a size, a material, or a placement of the at least one model guide relative to the model upper die and the model lower die.

7. The apparatus of claim 1, wherein the memory further store code executable by the processor to perform subsequent simulations using the spring coefficient to determine the model guide characteristics of the at least one model guide that prevent the model upper die from sliding at least the portion of sliding in the specified distance in the sliding direction.

8. The apparatus of claim 1, wherein the memory further stores code executable by the processor to generate manufacturing specifications for fabricating a physical hot form die that replicates the hot form die of the 3D model.

9. A hot form die, comprising:
an upper die;
a lower die configured to be positionable beneath and fixed relative to the upper die during a hot forming process; and
at least one guide coupled to one of the upper die or the lower die, and configured to guide the upper die, relative to the lower die, during the hot forming process,
wherein:
during the hot forming process for forming a part, the upper die is configured to be pressed towards the lower die, in a pressing direction along a z-axis extending through a centroid of the upper die;
during the hot forming process, the upper die is prevented from sliding at least a portion of a specified distance in a sliding direction within a sliding plane, which is perpendicular to the z-axis, by the at least one guide; and
the at least one guide comprises guide characteristics based on model guide characteristic of at least one model guide determined by an apparatus for predicting hot form die sliding, wherein the apparatus:
generates a 3D model of the hot form die, comprising a model upper model and a model lower die, wherein the model lower die is fixed, relative to the model upper die;
generates a hot forming process model for forming a part using the 3D model;
performs a baseline simulation of the hot forming process model to determine a sliding direction of the model upper die within a sliding plane, wherein the baseline simulation comprises pressing the model upper die towards the model lower die in a pressing direction along the z-axis extending through a centroid of the model upper die while allowing the model upper die to freely slide within the sliding plane, which is perpendicular to the z-axis;
based on the baseline simulation, calculates a spring coefficient applied at a spring reference point on the model upper die, offset aft of the centroid along the sliding plane, that allows the model upper die to slide the specified distance in the sliding direction within the sliding plane; and
generates the at least one model guide in the 3D model, wherein the at least one model guide comprises model guide characteristics that prevent the model upper die from sliding at least the portion of sliding in the specified distance in the sliding direction.

10. The hot form die of claim 9, wherein:
the upper die is fabricated to replicate the model upper die; and
the lower die is fabricated to replicate the model lower die.

11. The hot form die of claim 9, wherein:
the apparatus for predicting hot form die sliding generate multiple 3D models of the hot form die and performs multiple baseline simulations of the hot forming process model each corresponding with one of the multiple 3D models;
each one of the multiple 3D models is different from any other one of the multiple 3D models and is configured to make the part during the baseline simulation of the hot forming process model;
each one of the multiple 3D models is simulated to identify the one of the multiple 3D models that induces the least amount of sliding within the sliding plane; and
the upper die and the lower die are formed to replicate the model upper die and the model lower die of the one of the multiple 3D models that induces the least amount of sliding within the sliding plane.

12. The hot form die of claim 9, wherein:
the at least one guide comprises at least one guide block coupled to the upper die;
the lower die comprises a guide feature corresponding to the at least one guide block; and
the at least one guide block is configured to engage with the corresponding guide feature during the hot forming process.

13. The hot form die of claim 9, wherein:
the at least one guide comprises at least one guide block coupled to the lower die;
the upper die comprises a guide feature corresponding to the at least one guide block; and
the at least one guide block is configured to engage with the corresponding guide feature during the hot forming process.

14. The hot form die of claim 9, wherein guide characteristics of the at least one guide comprises at least one of a shape, a size, a material, or a placement of the at least one guide relative to the upper die and the lower die.

15. The hot form die of claim 9, wherein the upper die and the lower die are configured to be heated to at least 1150 degrees F. during the hot forming process.

16. A method of predicting die sliding during a hot forming process, comprising:
generating a 3D model of a hot form die, the 3D model comprising a model upper die and a model lower die, wherein the model lower die is fixed relative to the model upper die;
generating a hot forming process model for forming a part using the 3D model;
performing a baseline simulation of the hot forming process model to determine a sliding direction of the model upper die within a sliding plane, wherein the baseline simulation comprises pressing the model upper die towards the model lower die in a pressing direction along a z-axis extending through a centroid of the model upper die while allowing the model upper die to freely slide within the sliding plane, which is perpendicular to the z-axis;
based on the baseline simulation, calculating a spring coefficient applied at a spring reference point on the model upper die, offset aft of the centroid along the sliding plane, that allows the model upper die to slide a specified distance in the sliding direction within the sliding plane;
determining if at least a portion of sliding in the specified distance in the sliding direction is to be prevented; and
if determined that at least the portion of sliding in the specified distance in the sliding direction is to be prevented, generating at least one model guide in the 3D model, wherein the at least one model guide comprises model guide characteristics that prevent the model upper die from sliding at least the portion of sliding in the specified distance in the sliding direction.

17. The method of claim 16, wherein:
the step of generating the 3D model of a hot form die further comprises generating multiple 3D models of the hot form die; and
the step of performing the baseline simulation of the hot forming process model further comprises performing multiple baseline simulations of the hot forming process model each corresponding with one of the multiple 3D models;
wherein:
each one of the multiple 3D models is different from any other one of the multiple 3D models and is configured to make the part during the baseline simulation of the hot forming process model; and
each one of the multiple 3D models is simulated to identify the one of the multiple 3D models that induces the least amount of sliding within the sliding plane.

18. The method of claim 16, wherein:
the specified distance is determined using historical data comprising sliding data obtained during a physical hot forming process using a hot form die comprising an upper die with a similar geometry and a similar weight to the model upper die and a lower die with a similar geometry and a similar weight to the model lower die; and
the spring coefficient is calculated using the specified distance.

19. The method of claim 16, wherein:
the spring coefficient is calculated by multiplying a known spring coefficient of a second 3D model by a ratio of a first mass of the model upper die and a second mass of an upper die of the second 3D model; and
the specified distance is determined using the spring coefficient.

20. The method of claim 16, further comprises generating manufacturing specifications for fabricating a physical hot form die that replicates the hot form die of the 3D model.
